(19) United States
(12) Patent Application Publication
(10) Pub. No.: US 2014/0007205 A1
(43) Pub. Date: Jan. 2, 2014

(54) No-Click Log-In Access to User's Web Account Using a Mobile Device

(71) Applicant: Georgios Oikonomou, Aktaio (GR)

(72) Inventor: Georgios Oikonomou, Aktaio (GR)

(73) Assignee: Bytemobile, Inc.

(21) Appl. No.: 13/536,616

(22) Filed: Jun. 28, 2012

(51) Int. Cl. G06F 21/20

(52) U.S. Cl. 726/6

(57) ABSTRACT

A no-click log-in system and method allowing users to access their personal web accounts using a mobile device. The method comprises acquiring a web session identifier from a code provided on an entry webpage that is displayed on a computing device; generating an authorized token having information corresponding to at least the web session identifier and a mobile session identifier that corresponds to either an authenticated session with a service provider of the webpage or credentials to authenticate a session with the service provider; and providing the authorized token to a server, which receives the information corresponding to at least the web session identifier and the mobile session identifier from the authorized token, and uses at least the web session identifier and the mobile session identifier to authenticate the user with the service provider for providing access to a user-specific webpage that replaces the entry webpage on the computing device.

The embodiments described herein relate to a system and method that allow users to access their personal web accounts using a mobile device.

### BACKGROUND

The ubiquity of the Internet has led to a proliferation of web services such as email, online banking, social networking, etc. These web services typically have a log-in page or section on their websites, where users enter log-in credentials (in the form of unique user-names and passwords) before access to their accounts is granted. Different web services, however, have varying security requirements and impose different rules on the length and type of characters that can be used for log-in credentials. As a result, users who have a variety of different web accounts may need to remember a large number of different log-in credentials.

### BRIEF DESCRIPTION OF THE DRAWINGS

FIG. 1 illustrates an exemplary no-click log-in access system in accordance with some embodiments.

FIG. 2A is an exemplary functional block diagram of the no-click log-in access system of FIG. 1.

FIG. 2B illustrates exemplary placements of a uniquely recognizable visual code on a webpage shown in FIG. 2A.

FIG. 3 is a flow chart illustrating an exemplary method for implementing no-click log-in access on a computing device in accordance with some embodiments.

FIG. 4 is a flow chart illustrating an exemplary method for implementing no-click log-in access on a mobile device in accordance with some embodiments.

FIG. 5 is a flow chart illustrating an exemplary method for implementing no-click log-in access on a server in accordance with some embodiments.

FIG. 6 is an exemplary functional block diagram for installing the no-click log-in access system of FIG. 1.

FIG. 7 is an exemplary functional block diagram showing another embodiment of the no-click log-in access system of FIG. 1.

### DETAILED DESCRIPTION

Reference will now be made in detail to the exemplary embodiments illustrated in the accompanying drawings. Wherever possible, the same reference numbers will be used throughout the drawings to refer to the same or like parts.

The present disclosure relates to a no-click log-in access system and method that simplifies a user log-in process to the user's web account through a computing device using the user's mobile device. As stated previously in the Background section, users who have a variety of different web accounts may need to remember a large number of log-in credentials (which can include different user-names, email addresses, passwords, pin numbers, etc). Thus, it is common for some users to forget their log-in credentials for their web accounts, particularly those accounts which the users do not frequently access.

Typically, when a user forgets the user's log-in credentials to a web account, the user may need to visit a “Forget Password” link on the entry webpage of the user's web account. Different web services have different procedures (within the “Forget Password” link) to re-instate the user's access to the user's account. For example, in some instances, the web service may provide hints to the user to allow the user to recall the user's existing log-in credentials. In other instances, the web service may issue new log-in credentials to the user, which will reset the user's existing log-in credentials. Typically, before the web service provides hints or issues new log-in credentials to the user, the web service may first require the user to answer one or more security questions relating to personal details of the user, so as to verify the identity of the user. The above procedures, however, can create inconvenience and prevent a user from accessing the user's account in a timely manner, especially if the user is unable to answer the security questions correctly, or if repeated failed attempts by the user to access the user's web account has resulted in the web account being temporarily locked.

The no-click log-in access system and method described herein can allow a user who has forgotten the user's log-in credentials to a web account, to circumvent the conventional “Forget Password” procedures, by using the user's mobile device to log in to the web account on a computing device.

The no-click log-in access system and method described herein also provides an alternative to the conventional log-in process to a user's web account. The conventional log-in process typically requires a user to type and enter the user's credentials on the log-in page of a website. Using the no-click log-in access system and method, a user can opt to log in to the user's web account on a computing device using a mobile device, instead of typing and entering the user's credentials on the log-in page of a website on a computing device.

In some instances, a computing device may not readily come with a keyboard, or the computing device may come with a keyboard with foreign language keys. In those instances, it may be more convenient for the user to log in to the user's web account on the computing device using a mobile device (or perhaps the only way), particularly if the user's log-in credentials include special keys/characters, and the special keys/characters are not found on the keyboards of those computing devices.

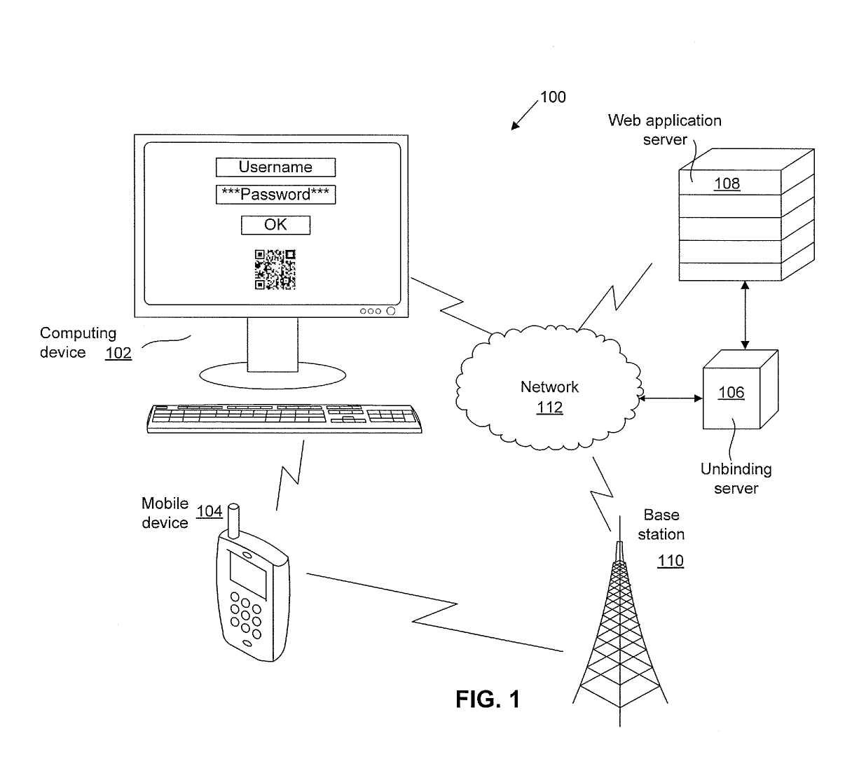

FIG. 1 illustrates an exemplary no-click log-in access system 100 that includes a computing device 102, a mobile device 104, an unbinding server 106, a web application server 108, a base station 110, and a network 112.

Each of computing device 102, mobile device 104, unbinding server 106, and web application server 108 includes one or more processors and at least one memory for storing program instructions, and one or more applications that reside on the memory and which are executable by the processor(s). The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the instructions can be implemented in hardware components or combinations of hardware and software such as, for example, ASICs, special purpose computers, or general purpose computers.

Computing device 102 is a device that can display one or more particular webpages. While computing device 102 is illustrated in the form of a desktop computer in FIG. 1, it is to be appreciated and understood that other types of computing devices can be utilized. For example, computing device 102 can include, among other things, laptops or notebook computers, tablet PCs, and video game systems. Computing device 102 can also include any other media content player, for example, a set-top box, a television set, or any electronic device capable of providing or rendering data.

Mobile device 104 is a device that has an application corresponding to the one or more particular webpages. Mobile device 104 is also capable of wireless transmission of data. Mobile device 104 can include, among other things, smartphones, cellphones, personal digital assistants (PDAs), and tablets. Moreover, mobile device 104 can include software and hardware for image capturing (e.g., a built-in camera), image processing, and image recognition. Using the image information, mobile device 104 can “bind” information together (further explained below) before transmitting data through network 112.

Mobile device 104 can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers.

Unbinding server 106 is a hardware device or software component that receives binded information from mobile device 104 and unbinds the information accordingly before providing the unbinded information to web application server 108. Unbinding server 106 can include a web server, an enterprise server, or any other type of computer server, and can be computer programmed to accept requests (e.g., HTTP, or other protocols that can initiate data transmission) from computing device 102 and mobile device 104, and to serve computing device 102 and mobile device 104 with requested data. In addition, unbinding server 106 can include a broadcasting facility, such as free-to-air, cable, satellite, and other broadcasting facility, for distributing data.

Unbinding server 106 can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers.

Web application server 108 can be any computer systems or software programs that is capable of serving the requests of clients, e.g., computing device 102 and mobile device 104. Web application server 108 can be any type of server including content server, application server, communication server, database server, proxy server, web server, caching server, and any other suitable servers. A webpage can be located at one content server, or a webpage can be located at multiple content servers. The objects in the webpage may not be located at one content server and can spread onto several content servers for the purpose of reducing server load, or for the purpose of using third party advertisements. Web application server 108 can communicate with network 112. In addition, web application server 108 can include a broadcasting facility, such as free-to-air, cable, satellite, and other broadcasting facility, for distributing data. In some embodiments, web application server 108 can include unbinding server 106.

Web application server 108 can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers.

In system 100, base station 110 can transmit telecommunication signals and data from mobile device 104 to unbinding server 106 and/or web application server 108 through network 112. Base station 110 can also compute cellular locations of mobile device 104 based on the signal strength of the wireless signal emitted from mobile device 104.

Computing device 102, mobile device 104, unbinding server 106, and web application server 108 can include software applications that allow device 102/104 and server 106/108 to communicate and receive data through network 112 or any local storage medium. Computing device 102 and mobile device 104 can be operatively connected to one another via network 112 or any type of communication links that allow transmission of data from one component to another. Network 112 can include Local Area Networks (LANs) and/or Wide Area Networks (WANs), and can be wireless, wired, or a combination thereof. Network 112 can extend onto the Internet, or it can be a peer-to-peer network. Network 112 can also include data networks such as a cloud computing network.

Although particular computing and mobile devices are illustrated and networks are described, it is to be appreciated and understood that other computing and mobile devices and networks can be utilized without departing from the spirit and scope of the embodiments described herein.

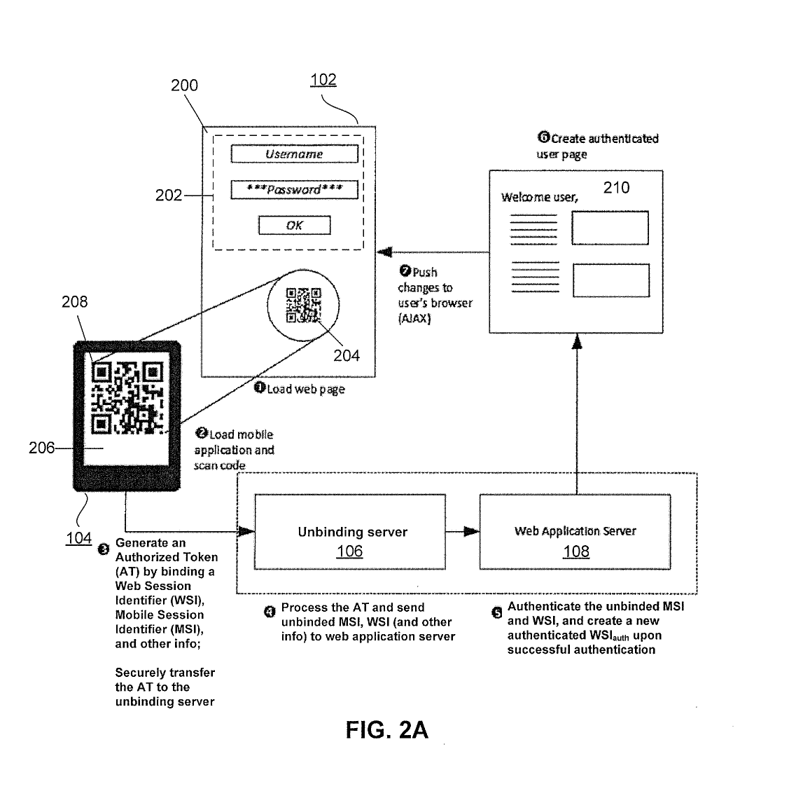

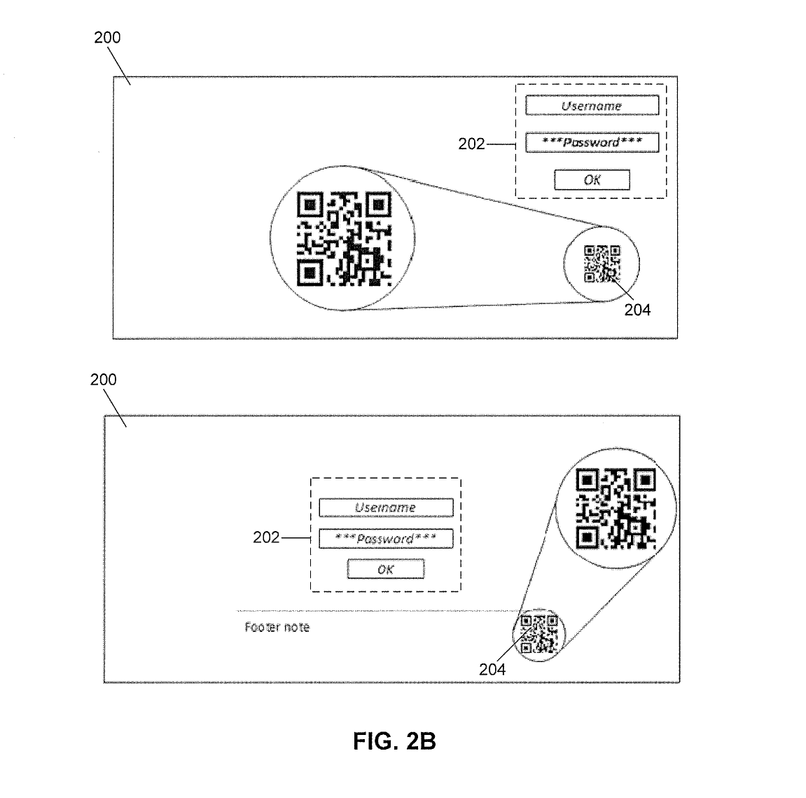

FIG. 2A is an exemplary functional block diagram of the no-click log-in access system of FIG. 1. The modules and interfaces shown in FIG. 2A can generally be categorized into the following components: (1) computing device 102; (2) mobile device 104; and (3) unbinding server 106 and web application server 108.

After a user has entered a URL, at step 1, computing device 102 loads webpage 200 corresponding to the URL using a web-browser (e.g. Internet Explorer™, Mozilla Firefox∩, Apple Safari™, etc.) installed on computing device 102.

Webpage 200 can be an entry webpage to the user's private or password-protected web account on a website, where the user is required to enter the user's log-in credentials on the entry page before the user can obtain access to the user's web account. The website may be provided by a service provider (for example, Facebook™, Gmail∩, Bank of America™, etc.), and the service may be any type of service, such as social networking, email, online banking, etc. In some embodiments, after a service provider has authenticated the user's log-in credentials, the service provider can provide the user access to a user-specific webpage that replaces the entry webpage (e.g., webpage 200) on computing device 102. The user-specific webpage can contain personal information relating to a user. For example, the user-specific webpage for a user's email account (e.g. Gmail™) contains personal emails of the user.

As shown in FIG. 2A, webpage 200 includes log-in window 202 prompting the user for the user's log-in credentials. Conventionally, the user can access the user's account after correctly entering the user's log-in credentials in log-in window 202, and after web application server 108 (which hosts the website) has authenticated the user's log-in credentials. In some cases, web application server 108 may require the user to enter an extra PIN code or Captcha code, usually to unlock an advanced privilege level. For example, an extra PIN code or Captcha code may be required when passwords are reset, or after repeated login failures by the user.

Webpage 200 further includes a uniquely recognizable visual code 204. Code 204 can be located under the log-in credentials input fields (e.g. log-in window 202) or in the footer note of webpage 200, as shown in the top and bottom of FIG. 2B, respectively. The dimensions of code 204 on webpage 200 should be adequate such that a clear image of code 204 can be easily captured by a built-in camera on mobile device 104.

In FIGS. 2A and 2B, code 204 is illustrated as a 2-dimensional Quick Response (QR) barcode. The QR barcode includes square dots arranged in a square pattern on a white background. The information encoded in the QR barcode can be made up of four standardized kinds (“modes”) of data (numeric, alphanumeric, byte/binary, Kanji), or virtually any kind of data that is supported through other types of extensions.

Alternatively, in other embodiments, code 204 can be a 1-dimensional barcode, such as a Universal Product Code (UPC).

In addition to 1-dimensional and 2-dimensional barcodes, code 204 can include other custom codes, depending on the application context and the amount of information that needs to be encoded. For example, code 204 can be a sequence of alphanumeric characters (including symbols), which can be captured as images by the mobile device. In situations in which code 204 includes a sequence of alphanumeric characters, a user can manually enter the sequence into mobile device 104.

In some embodiments, code 204 contains a unique Web Session Identifier (WSI), which corresponds to a token that is unique for each visit to webpage 200. In those embodiments, a unique token is generated each time webpage 200 is loaded or refreshed, even if the action of loading or refreshing webpage 200 is performed by the same user. The unique token is granted for a specific web session (the web session can be defined by its duration and/or purpose), and once the token expires, it is invalidated and a new token (WSI) can be generated for the next web session.

In some embodiments, the WSI can include a string of alphanumeric characters or a binary code, with the size of the WSI dependent on a website's security needs and/or applications. For example, a website that requires high security (such as a website that provides online banking or e-commerce services) may employ a longer-stringed WSI, which may in turn require a more complex and larger-sized barcode.

In some embodiments, the website (which webpage 200 is part of) is built with technology that enables asynchronous push updates to any of the website elements. For example, the website can include an AJAX (Asynchronous JavaScript and XML) framework that can update the nodes of a Document Object Model (DOM) tree. The AJAX framework is a framework in web application development that leverages asynchronous JavaScript and XML, which are a collection of technologies for building dynamic web pages on the client side. The AJAX framework is also a cross-browser framework that allows developers to quickly develop web pages that can call web services, web pages, and other types of content through JavaScript without having to submit the current page.

When a website includes an AJAX framework, external events such as software and webpage updates (which are implemented by a service provider or web developer on web application server 108) can be asynchronously pushed from web application server 108 to the web-browser on computing device 102, without requiring any action from the user. Subsequently, webpage 200 and/or other pages of the website, that are loaded in the web-browser on computing device 102, can be updated with updates that have been asynchronously pushed from web application server 108.

As shown in step 2 of FIG. 2A, after webpage 200 has been loaded, the user loads mobile application 206 on the user's mobile device 104. In some embodiments, mobile application 206 is affiliated with a service provider (for example, a first mobile application 206 may be affiliated with Facebook™, and a second mobile application 206 may be affiliated with Gmail™). In the above exemplary embodiments, a user may use the first mobile application 206 to access the user's Facebook™ account, and the second mobile application 206 to access the user's Gmail™ account.

In other embodiments, mobile application 206 can be a single application that is affiliated with different service providers (such as Facebook™, Gmail™, Bank of America™, etc.). In those other embodiments, a user can use mobile application 206 to access web accounts provided by the different service providers that mobile application 206 is affiliated with. In other words, the user can use a single mobile application 206 to access the user's different web accounts.

Mobile application 206 can store the log-in credentials of a user for a web account, in the form of a Mobile Session Identifier (MSI). The MSI can be in either encrypted or non-encrypted form. In some embodiments, the MSI can include the user's log-in credentials for different web accounts. In some embodiments, MSI corresponds to an already authenticated session on mobile device 104.

In the no-click log-in access system and method, mobile application 206 can allow a user to log in to the user's web account using the log-in credentials in the MSI in conjunction with the WSI, which will be described in further detail below.

In the example of FIG. 2A, mobile device 104 comes equipped with a built-in camera, and mobile application 206 includes Visual Code Detection Screen (VCDS) 208, which activates the built-in camera on mobile device 104 to scan code 204. In some embodiments, VCDS 208 can be natively embedded in mobile application 206. In other embodiments, VCDS 208 can be part of an externally used third-party application in smartphone platforms (e.g. Android™, Apple Apps™) that support such a feature. It is noted that VCDS 208 can be connected with other parts of mobile application 206 through a “click” action, e.g. an icon, a menu item, etc.

As shown in step 2 of FIG. 2A, the user uses the camera and VCDS 208 in mobile application 206 on mobile device 104 to capture an image of code 204, by scanning code 204 displayed on webpage 200 of computing device 102. It is appreciated that other means for capturing the WSI can be used. For example, a bar code scanner could obtain the WSI from code 204.

After code 204 has been scanned using the camera and VCDS 208, mobile application 206 reads scanned code 204 using visual code libraries stored in a memory of mobile device 104 (the reading includes visual recognition of codes), and derives the WSI (unique token) contained in code 204. It is noted that other custom visual recognition solutions can also be applied (for example, using custom barcodes with a custom reader utilizing computer vision techniques).

In some embodiments, after mobile application 206 has derived the WSI contained in code 204, mobile application 206 transmits the WSI and MSI as data to a server. In other embodiments, mobile application 206 processes the WSI and MSI before transmitting the processed WSI and MSI to a server. In some other embodiments, mobile application 206 encrypts the WSI and MSI before transmitting the encrypted WSI and MSI to a server.

In some embodiments, mobile application 206 binds the WSI derived from code 204 and the MSI in mobile application 206 using a Bind function, which includes binding the WSI (e.g., unique token) provided in code 204, with the MSI (e.g., containing the user's log-in credentials) in mobile application 206. In some other embodiments, the WSI and MSI are not binded before the WSI and MSI are transmitted to a server.

In some embodiments, an invertible function or encryption method can be used as the Bind function. For example, the Bind function can include: (1) a clear-text method for sending information to a server; (2) a cipher or encryption method that can encode the necessary information (such as public key cryptography methods); (3) any custom and/or proprietary method that can multiplex/de-multiplex the information; or (4) compression techniques that can be combined with any of the above methods, and which can be used to reduce the payload on a server.

In some embodiments, mobile application 206 generates an authorized token (AT) when the WSI and MSI are binded using a Bind function:

AT=Bind(WSI, MSI)

In some embodiments, the Bind function can accept any number of inputs from either computing device 102 and/or mobile device 104, in addition to the WSI from computing device 102 and MSI in mobile device 104. In other words, additional information can be passed on through the inputs from computing device 102 and/or mobile device 104 to unbinding server 106 using the Bind function, by incorporating additional information (extras) in the Bind function:

AT=Bind(WSI, MSI, extras)

The additional information (extras) can include, among other things: (1) location of mobile device 104; (2) network related information; (3) credentials of mobile device 104; (4) state of mobile application 206; (5) pin code for returning to a web session after a period of inactivity; (6) enhanced security via face or voice recognition; and/or (7) use of device accelerometer data on webpage 200. Each of the above types of information is described in further detail as follows:

1. Location of Mobile Device 104

The location of mobile device 104 includes any location-based information that can be retrieved either by Global Positioning Systems (GPS) or any other available location provider on mobile device 104. Other means of determining the location of mobile device 104 include physical beacons located within mobile device 104 that broadcast the location of the beacon (e.g. Bluetooth or 802.11 beacons).

The Bind function can be configured to encode location information of mobile device 104. For example, if Lat represents the latitude, Lon represents the longitude, and r represents an estimate of the radius around the location of mobile device 104, the variables [Lat, Lon, r] can be incorporated into the extras fields of the Bind function:

extras=[Lat, Lon, r]

When the authorized token is unbinded at unbinding server 106, the location coordinates from the unbinded location information can be used such that a website hosted on web application 108 can receive the location of mobile device 104 (with an estimated radius r around the location).

Thus, the above technique presents an alternative to conventional methods of detecting a user's location, which typically require a user to enter the user's physical address location into a map application in the browser, or give the browser the permission to automatically retrieve user's location by using the Geolocation API or any other similar technique.

In some embodiments, after unbinding server 106 has unbinded the authorized token containing location information of mobile device 104, and sent the unbinded location information to web application server 108, web application server 108 can provide Location-Based advertising services to the user through an authenticated web session, based on the user's location as conveyed by mobile device 104.

2. Network Related Information

Network related information can include IP addresses of a network. In some cases, information about the user's current network (for example, whether it is a home, work, or public network, as well as details about the Internet Service Providers, etc.) can be obtained through an IP address when the IP address is checked against IP-to-location database or a Who-is™ database. By using the network information, a service provider can track the user's mobility. For example, if the network related information shows that a user is scanning code 204 over a mobile network connection, this can mean that the user is on the move, or that the user may be viewing the website on a public computer. Thus, a service provider can leverage the network related information with the location information of mobile device 104 to customize each user's web experience by providing customized location-based content to different users, or optimizing the web content appropriately.

3. State of Mobile Application 206

Application-specific data, such as recent browsing history and current state of mobile application 206, can also be transmitted as input to web application server 108 after unbinding server 106 has unbinded the authorized token containing the application-specific data received from mobile application 206. Based on application-specific data (such as usage history of mobile device 104), a service provider can customize and display content that the service provider believes will appeal to the user.

The extras field can be an application-specific set of information that describes the current state and past activity on mobile device 104. For example, in a mobile messaging application that includes a history of a user's messaging conversations, a user can scan code 204 and instantly connect to the website where the user can immediately access and continue the user's messaging conversations from the point where the conversations were left at on mobile device 104.

4. Pin Code for Returning to a Web Session after a Period of Inactivity

A server-generated PIN can also be transmitted in the extras field to ensure that an authenticated user is still logged in to a website, and that the current web session is still active. For example, after a period of inactivity on the web-browser of computing device 102 resulted in the web session being locked, web application server 108 can request a PIN to be typed in on mobile application 206 on mobile device 104 (or webpage 200 on computing device 102), so as to verify that the user is still actively engaged in the session. Entry of the PIN in mobile application 206 or on webpage 200 can then re-activate a timed-out session.

The PIN can be a digit number, a string, or a new visual code. If the PIN is a digit number, the user can enter the PIN in mobile application 206. If the PIN is a visual code, such as code 204, VCDS 208 on mobile application 206 can be used to scan the code and retrieve the PIN. The PIN can be automatically attached to the Bind function in the extras field of the authorized token, sent to unbinding server 106 for unbinding, and subsequently sent to web application server 108, which re-activates the locked session after receiving the unbinded

PIN.

It is noted that the above technique can be used in applications that require strict session timeouts, such as web banking applications.

5. Enhanced Security via Face or Voice Recognition

In some embodiments, enhanced security can be provided via face and/or voice recognition. In those embodiments, the extras field can include a binary file such as a digital photo or a voice recording.

In some embodiments, a user can take a photo of him/herself using a camera on mobile device 104, and/or record a voice recording using a microphone on mobile device 104. The photo or audio message can be attached in the extras field of the authorized token and sent to unbinding server 106, which can then unbind the authorized token. A face and/or voice recognition can subsequently be performed at unbinding server 106 (or web application server 108, if unbinding server 106 sends the unbinded photo or audio message to web application server 108 for face and/or voice recognition).

If the face/voice recognition is successful (i.e. the person who carries mobile device 104 and requests access is the authorized person for the login), the no-click log-in access is complete and the user can access the user's web account. If the face/voice recognition is unsuccessful, the website can display an error message and prevent the user from accessing the web account.

In some embodiments, mobile device 104 can record and archive photos or other biometric data of the person requesting log-in to the website.

6. Use of Device Accelerometer Data in Webpage 200

In some embodiments, the extras field can include sensor data transmitted by mobile device 104. For example, mobile application 206 on mobile device 104 can transmit sensor data to a website throughout the duration of a web session. The sensor data can include accelerometer data among others. In those embodiments, web application server 108 and mobile application 206 maintain an open communications channel through unbinding server 106. The open communications channel allow physical motions of a user to be read, by processing accelerometer data in the extras field of the authorized token that is sent to the web application server 108 (note that the authorized token is first unbinded at unbinding server 106) when the user physically moves mobile device 104. For example, sensor information is transmitted whenever new data is available, i.e. when a sensor callback function is invoked.

Examples of applications using the accelerometer data include using mobile device 104 to control perspective in a 3-D application, such as maps or virtual reality applications. Once mobile device 104 and web application server 108 are connected, an open channel is maintained thereby allowing accelerometer data to be transmitted from mobile device 104 to unbinding server 106 and on to web application server 108. Based on the received accelerometer data, web application server 108 can process and push a new perspective to the web surface to orientate the user. In this way, mobile device 104 can be used to control a 3-D navigation in a maps or virtual reality application, or used as a controller in online web games.

Returning to step 3 of FIG. 2A, following the binding of the WSI and MSI (and other information) using the Bind function, mobile application 206 securely transfers the binded WSI and MSI (and other information), in the form of an authorized token, to unbinding server 106. The transfer can include mobile application 206 providing the authorized token (as text or binary octet stream) securely, e.g. over HTTPS or any other custom secure protocol, to unbinding server 106. As shown in steps 4-6 of FIG. 2A, the combination of unbinding server 106 and web application server 108 initiates the process of replacing the entry webpage on webpage 200 with an authenticated user page 210, which proceeds as though the user had logged in to the entry webpage on computing device 102 by typing the user's log-in credentials in log-in window 202. In some embodiments, authenticated user page 210 can be a user-specific webpage.

After unbinding server 106 receives the WSI and MSI (and other information) binded in an authorized token from mobile application 206, unbinding server 106 processes the authorized token by unbinding the WSI and MSI (and other information), and sends the unbinded WSI and MSI (and other information) to web application server 108 (step 4).

In some embodiments, unbinding server 106 processes the authorized token (AT) by inverting the authorized token using a Bind⁻¹ function to retrieve the WSI and MSI:

(WSI, MSI)=Bind⁻¹(AT)

The Bind⁻¹ function is the inverse of the Bind function. The Bind⁻¹ function can retrieve the initial data without any losses, such that the integrity of the binded data is maintained during the unbinding process.

As stated previously, additional information can be passed to unbinding server 106 using the Bind function. For example, the Bind function can take additional information (extras) in addition to the WSI and MSI, as shown by the following authorized token (AT):

AT=Bind(WSI, MSI, extras)

When additional information has been passed to unbinding server 106 using the Bind function, the inverse function at unbinding server 106 will return the additional information when the authorized token (AT) is unbinded:

(WSI, MSI, extras)=Bind⁻¹(AT)

For example, if the additional information includes the location of mobile device 104 and network related information, unbinding server 106 can pass the additional information, as well as the WSI and MSI, to web application server 108 after the unbinding of the authorized token.

With reference to step 5 of FIG. 2A, web application server 108 authenticates at least the unbinded WSI and MSI received from unbinding server 106. Successful authentication of the unbinded WSI and MSI includes verifying an open and valid web session loaded in the web-browser on computing device 102 based on the WSI, and verifying the user's log-in credentials in the MSI. In the event that the web session is no longer valid (for example, after the session has timed out, the web-browser window has been closed, etc.) or the MSI is invalid (for example, incorrect user log-in credentials), the authentication fails and web application server 108 can return an appropriate error message to mobile device 104 and/or computing device 102 informing the user the cause of the authentication failure.

In some embodiments, to improve the user's experience, webpage 200 on computing device 102 and/or VCDS 208 on mobile device 104 can include a percentage bar or waiting dialog showing the progress of the authentication.

Upon successful authentication of the unbinded WSI and MSI, web application server 108 creates a new authenticated Web Session Identifier WSIₐᵤₜₕ (step 5). After the WSIₐᵤₜₕ is created, an authenticated user page 210 (which can include a “Welcome User” message as shown in FIG. 2A) replaces webpage 200 in the web-browser on computing device 102 (step 6), allowing the user to access the contents in the user's web account.

As illustrated in step 7 of FIG. 2A, website updates can be asynchronously pushed from web application server 108 to the web-browser on computing device 102 if the website includes an AJAX framework or a similar “push” framework. That is, after the WSIₐᵤₜₕ is created, web application server 108 can asynchronously update and push the page that would have been displayed if the user had logged in using the keyboard of computing device 102 to type in the user's credentials. Thus, in some embodiments, web application server 108 can access and control any open web session using asynchronous push messages.

In some embodiments, web application server 108 may require the WSIₐᵤₜₕ to be re-validated after a certain period of time (for example, after a period of inactivity by the user). In other embodiments, web application server 108 may require the WSIₐᵤₜₕ to be re-validated when a user attempts to access parts of the website that require higher security. In the above embodiments, web application server 108 can push a message to mobile application 206 to request a PIN number, and/or request the same PIN number on webpage 200 at the same time, to allow the user to re-validate the WSIₐᵤₜₕ.

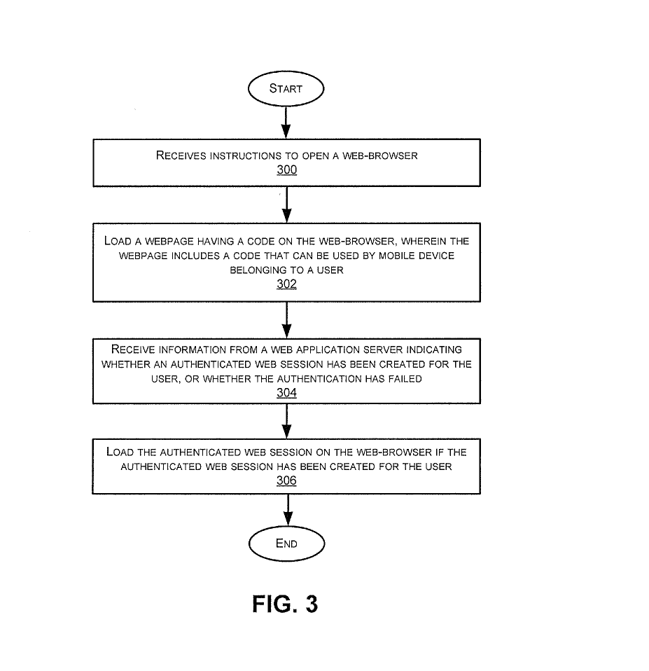

FIG. 3 is a flow chart illustrating an exemplary method for implementing no-click log-in access on a computing device (e.g. computing device 102) in accordance with some embodiments. While the flowchart discloses the following steps in a particular order, it is appreciated that at least some of the steps can be moved, modified, combined, or deleted where appropriate.

As shown in step 300 of FIG. 3, the computing device receives instructions to open a web-browser (e.g. Internet Explorer™, Mozilla Firefox™, Apple Safari™, etc.). In step 302, the computing device loads a webpage (e.g. webpage 200) on the web-browser after receiving a URL address or bookmark of a website that the user wishes to access. The website may be provided by a service provider (e.g., Facebook™, Gmail™, Bank of America™, etc.), and the service may be any type of service, such as social networking, email, online banking, etc.

In some embodiments, the webpage can be the home page of a website, and can include a log-in window (e.g. log-in window 202). In other embodiments, the webpage can be an entry webpage (that includes a log-in window) to a user's private or password-protected web account on a website. In some other embodiments, the webpage can provide hyperlinks that the user can click on to access the log-in window. Conventionally, the user can access the user's account after correctly entering the user's log-in credentials in the log-in window, and after a web application server (e.g., web application server 108) hosting the website has authenticated the user's log-in credentials. After the web application server has authenticated the user's log-in credentials, the web application server can provide the user access to a user-specific webpage that replaces the entry webpage (e.g. webpage 200) on the computing device.

In some cases, the web application server may require the user to enter an extra PIN code or Captcha code, usually to unlock an advanced privilege level. For example, an extra PIN code or Captcha code may be required when passwords are reset, or after repeated login failures by the user.

In some embodiments, the webpage includes a uniquely recognizable visual code (e.g. code 204). The code can be located under the log-in window of the webpage or in a footer note of the webpage (as shown, for example, in the top and bottom of FIG. 2B, respectively). The dimensions of the code on the webpage should be adequate such that a clear image of the code can be easily captured by a built-in camera on a user's mobile device (e.g. mobile device 104). The webpage can further include a set of instructions (or a hyperlink to an instructions page) instructing the user on how to scan the code using a mobile application (e.g. mobile application 206) and the built-in camera on the mobile device. In some embodiments, the mobile application includes a Visual Code Detection Screen (VCDS) (e.g. VCDS 208).

To access their web account, users can either enter their credentials in the log-in window on the webpage, or use the no-click log-in access method. In the no-click log-in access method, users log into their web accounts by first scanning the code on the webpage using the mobile application and camera on the mobile device.

In the flowchart of FIG. 3, it is assumed that the user chooses the no-click log-in access method, in which the user scans the code using the camera and VCDS in the mobile application on the mobile device. After the code has been scanned, the mobile application generates an authorized token, by binding a Web Session Identifier (WSI) contained in the code with a Mobile Session Identifier (MSI) stored in the mobile application on the mobile device. Additional information can also be included and binded with the WSI and MSI in the authorized token, and the additional information includes, but is not limited to: (1) location of the mobile device; (2) network related information; (3) credentials of the mobile device; (4) state of the mobile application; (5) pin code for returning to a web session after a period of inactivity; (6) enhanced security via face or voice recognition; and/or (7) use of device accelerometer data on the webpage.

In some embodiments, after the mobile application has derived the WSI contained in the code, the mobile application can transmit the WSI and MSI directly to a server. In other embodiments, the mobile application can process the WSI and MSI before transmitting the processed WSI and MSI to a server. In some other embodiments, the mobile application can encrypt the WSI and MSI before transmitting the encrypted WSI and MSI to a server.

In the exemplary method of FIG. 3, it is assumed that the mobile application sends the WSI and MSI (and other information) binded in an authorized token to an unbinding server (e.g. unbinding server 106) through a base station (e.g. base station 110) and a network (e.g. network 112).

After the unbinding server has unbinded the authorized token and retrieved the WSI and MSI, the unbinding server sends the unbinded WSI and MSI to the web application server for authentication. Depending on the results of the authentication of the WSI and MSI at the web application server, the computing device receives information from the web application server indicating whether an authenticated web session has been created for the user, or whether the authentication has failed (step 304). If an authenticated web session has been created for the user, the computing device loads the authenticated web session on the web-browser for the user (step 306), and the user can access the user's personal account through an authenticated user page (e.g. authenticated user page 210). If the authentication fails, the web application server can return an appropriate error message to the mobile device and/or computing informing the user the cause of the failed authentication.

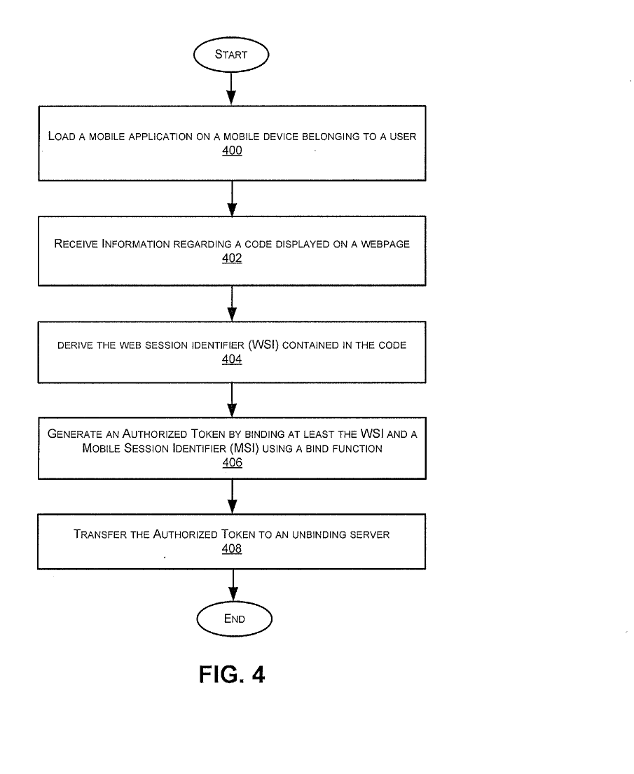

FIG. 4 is a flow chart illustrating an exemplary method for implementing no-click log-in access on a mobile device (e.g., mobile device 104) in accordance with some embodiments. While the flowchart discloses the following steps in a particular order, it is appreciated that at least some of the steps can be moved, modified, combined, or deleted where appropriate.

First, a user loads a mobile application (e.g. mobile application 206) on the mobile device belonging to the user (step 400). In some embodiments, the mobile application may already be loaded on the mobile device. The mobile application can store the log-in credentials of the user for a particular web account in the form of a Mobile Session Identifier (MSI). The MSI can be in either encrypted or non-encrypted form.

Next, in step 402, the mobile device receives information regarding a code (e.g., code 204) on a webpage (e.g., webpage 200) displayed on a computing device (e.g. computing device 102). The code can be a uniquely recognizable visual code. The mobile device can scan the code using a Visual Code Detection Screen (e.g. VCDS 208) in the mobile application and a built-in camera on the mobile device, as previously described with reference to FIG. 2. In some embodiments, the code can be a bar code or a sequence of alphanumeric characters (including symbols), both of which can be captured as images by the mobile device. In situations in which the code includes a sequence of alphanumeric characters, a user can manually enter the sequence into the mobile device.

In step 404, the mobile application derives a Web Session Identifier (WSI) contained in the code. In some embodiments, the mobile application reads the scanned code using visual code libraries stored in a memory of the mobile device (the reading includes visual recognition of codes). It is noted that other custom visual recognition solutions can also be applied (for example, using custom barcodes with a custom reader utilizing computer vision techniques).

In the no-click log-in access system and method, the mobile application can allow a user to log in to the user's web account using the log-in credentials in the MSI in conjunction with the WSI.

In some embodiments, after the mobile application has derived the WSI contained in the code, the mobile application can transmit the WSI and MSI directly to a server. In other embodiments, the mobile application can process the WSI and MSI before transmitting the processed WSI and MSI to a server. In some other embodiments, the mobile application can encrypt the WSI and MSI before transmitting the encrypted WSI and MSI to a server.

In some embodiments, the mobile application binds the WSI and the MSI using a Bind function, which includes binding the WSI (e.g., unique token) provided in the code, with the MSI (e.g., containing the user's log-in credentials) in the mobile application. In some other embodiments, the WSI and MSI are not binded before the WSI and MSI are transmitted to a server.

It is assumed that the WSI and MSI are binded in the exemplary method of FIG. 4. With reference to step 406 of FIG. 4, the mobile application generates an authorized token by binding at least the WSI and MSI using a Bind function. As stated previously, additional information can also be included and binded with the WSI and MSI in the authorized token, and the additional information includes, but is not limited: (1) location of the mobile device; (2) network related information; (3) credentials of the mobile device; (4) state of the mobile application; (5) pin code for returning to a web session after a period of inactivity; (6) enhanced security via face or voice recognition; and/or (7) use of device accelerometer data on the webpage.

In some embodiments, an invertible function or encryption method can be used as the Bind function. For example, the Bind function can include: (1) a clear-text method for sending information to a server; (2) a cipher or encryption method that can encode the necessary information (such as public key cryptography methods); (3) any custom and/or proprietary method that can multiplex/de-multiplex the information; or (4) compression techniques which can be combined with any of the above methods, and which can be used to reduce the payload on a server.

In step 408, the mobile application in the mobile device transfers the authorized token (containing the binded WSI, MSI, and possibly other information) to an unbinding server (e.g., unbinding server 106) for unbinding of the authorized token. It is noted that the transfer can include returning the authorized token (as text or binary octet stream) securely, e.g., over HTTPS or any other custom secure protocol, to the unbinding server.

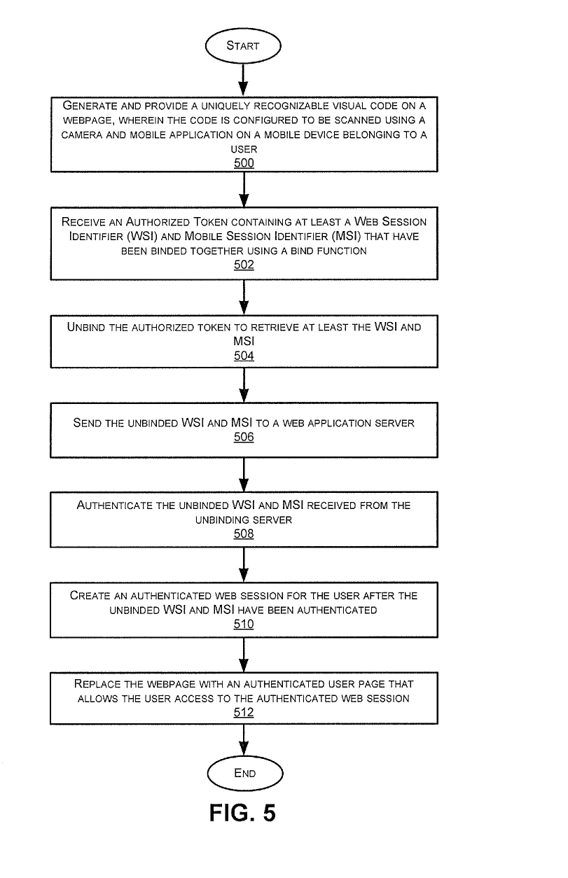

FIG. 5 is a flow chart illustrating an exemplary method for implementing no-click log-in access on an unbinding server (e.g. unbinding server 106) and a web application server (e.g. web application server 108) in accordance with some embodiments. In some embodiments, the unbinding server and the web application server can be part of the same server. While the flowchart discloses the following steps in a particular order, it is appreciated that at least some of the steps can be moved, modified, combined, or deleted where appropriate.

First, it is assumed that the web service is hosted on the web application server. In step 500, the web service generates and provides, via the web application server, a uniquely recognizable visual code (e.g., code 204) on a webpage (e.g., webpage 200), wherein the code is configured to be scanned using a built-in camera and a mobile application (e.g., mobile application 206) on a mobile device (e.g., mobile device 104) belonging to a user. In some embodiments, instead of generating and providing a visual code, the web application server can generate a code including a sequence of alphanumeric characters (including symbols) that can be entered into a mobile device.

In step 502, the unbinding server receives an authorized token from the mobile application on the mobile device. The authorized token includes at least a Web Session Identifier (WSI) and Mobile Session Identifier (MSI) that have been binded together by the mobile device. In some embodiments, the authorized token can include other information, such as: (1) location of the mobile device; (2) network related information; (3) credentials of the mobile device; (4) state of the mobile application; (5) pin code for returning to a web session after a period of inactivity; (6) enhanced security via face or voice recognition; and/or (7) use of device accelerometer data on the webpage.

After receiving the authorized token, at step 504, the unbinding server 106 unbinds the authorized token to retrieve at least the WSI and MSI (and any other information). After at least the WSI and MSI have been retrieved, the unbinding server sends the unbinded WSI and MSI to the web application server (step 506). The web application server then authenticates the unbinded WSI and MSI received from the unbinding server (step 508). If the authentication is successful (e.g., if the MSI and WSI have been verified and are valid), the web application server creates an authenticated web session for the user (step 510). In some embodiments, the web application server creates a newly authenticated Web Session Identifier (WSIₐᵤₜₕ) for the user. Finally, the web application server replaces the webpage with an authenticated user page (e.g., authenticated user page 210) on the computing device, allowing the user to access the contents in the user's web account through the authenticated web session (step 512). However, in the event that the authentication at the web application fails (e.g., either WSI or MSI or both are invalid), the web application server returns a log-in failure message to the computing device (displayed in the web-browser) and/or the mobile device (displayed in the mobile application).

As described previously, after the WSI and MSI have been authenticated and an authenticated web session has been created for the user, the web application server can asynchronously update the webpage if the website uses an AJAX framework or a similar “push” framework.

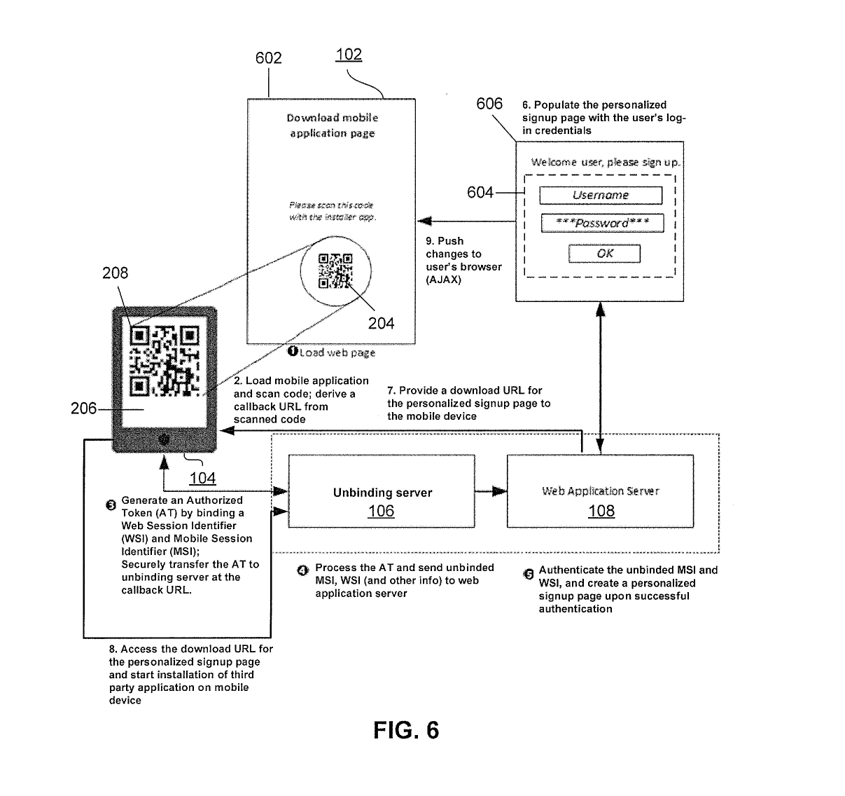

FIG. 6 is a functional block diagram showing modules and interfaces where mobile application 206 is used as a general purpose mobile application installer. Similar to the embodiment of FIG. 2, the modules and interfaces in FIG. 6 can generally be categorized into each of three components: (1) computing device 102; (2) mobile device 104; and (3) unbinding server 106 and web application server 108.

A third-party application can be a mobile application that can be used to download the application with the credentials “preinstalled.” An advantage of having preinstalled credentials is to avoid on-device sign-up procedures. Conventionally, when a user downloads and opens a third-party application for the first time, the user may be prompted to sign up for a new user account by entering the user's credentials in a webpage sign-up window (e.g., sign-up window 604 of webpage 606) through a sign-up procedure.

In some instances, a developer for third-party application and/or the third-party vendor can have the means to allow automatic user configuration. For example, the developer and/or the third-party vendor (e.g., third-party vendors in the Android™ market) can provide a way to add the user's log-in credentials in a download bundle, or provide the necessary links for automatic sign-up (e.g., providing mobile application 206 with a callback URL to a webpage where the user's log-in credentials information can be automatically populated). In those instances, mobile application 206 can allow a user to circumvent the above conventional sign-up procedure, by using mobile application 206 as a general purpose mobile application installer to install third-party application.

In the example of FIG. 6, mobile application 206 has permissions to retrieve a user's log-in credentials that are used to activate the user's web account (e.g., Apple ID™, Gmail™, Windows Live ID™, etc.) on mobile device 104. Mobile application 206 can then use the user's log-in credentials to activate and download (already activated) third-party application onto mobile device 104 through unbinding server 106 and web application server 108.

In the example of FIG. 6, mobile application 206 has access to the user's log-in credentials that are included in a Mobile Session Identifier (MSI) on mobile device 104. Also, a uniquely recognizable visual code 204 on webpage 602 contains information regarding a callback URL to webpage 606, at which the user's log-in credentials will be sent. In some embodiments, code 204 can be a bar code or a sequence of alphanumeric characters (including symbols), both of which can be captured as images by the mobile device. In situations in which code 204 includes a sequence of alphanumeric characters, a user can manually enter the sequence into mobile device 104.

In step 1, a user loads webpage 602 (“Download mobile application page”) in the web-browser on computing device 102. Webpage 602 includes code 204, with a message above code 204 prompting the user to scan code 204 using mobile application 206.

In step 2, the user loads mobile application 206 on mobile device 104, and scans code 204 using mobile application 206 and a built-in camera on mobile device 104. After the user has scanned code 204, mobile application 206 derives the callback URL from code 204.

In step 3, mobile application 206 generates an authorized token by binding at least a Web Session Identifier (WSI) and Mobile Session Identifier (MSI) using a Bind function. In some embodiments, the authorized token can include other information, such as: (1) location of the mobile device; (2) network related information; (3) credentials of the mobile device; (4) state of the mobile application; (5) pin code for returning to a web session after a period of inactivity; (6) enhanced security via face or voice recognition; and/or (7) use of device accelerometer data on the webpage.

Continuing with step 3, mobile device 104 next securely transfers the authorized token to unbinding server 106 at the callback URL. In step 4, unbinding server 106 processes the authorized token by unbinding the authorized token to retrieve at least the WSI and MSI (and any other information), and sends the unbinded WSI and MSI (and any other information) to web application server 108 for authentication. In step 5, after the WSI and MSI have been authenticated, web application server 108 creates a personalized signup page 606 for the user. In step 6, web application server 108 populates personalized signup page 606 with the user's log-in credentials, and in step 7, provides a download URL for the personalized signup page 606 to mobile device 104.

In step 8, the web-browser on mobile device 104 accesses the download URL, which starts the installation of third-party application on mobile device 104. The user can begin using third-party application when the installation is complete, without having to go through the conventional sign-up procedure.

In step 9, website updates can be asynchronously pushed from web application server 108 to the web-browser on computing device 102 if the website includes an AJAX framework or a similar “push” framework. That is, after the user has signed up and logged into the web account, web application server 108 can asynchronously update and push the page that would have been displayed if the user had logged in using the keyboard to type in his credentials. Thus, in some embodiments, web application server 108 can access and control any open web session using asynchronous push messages.

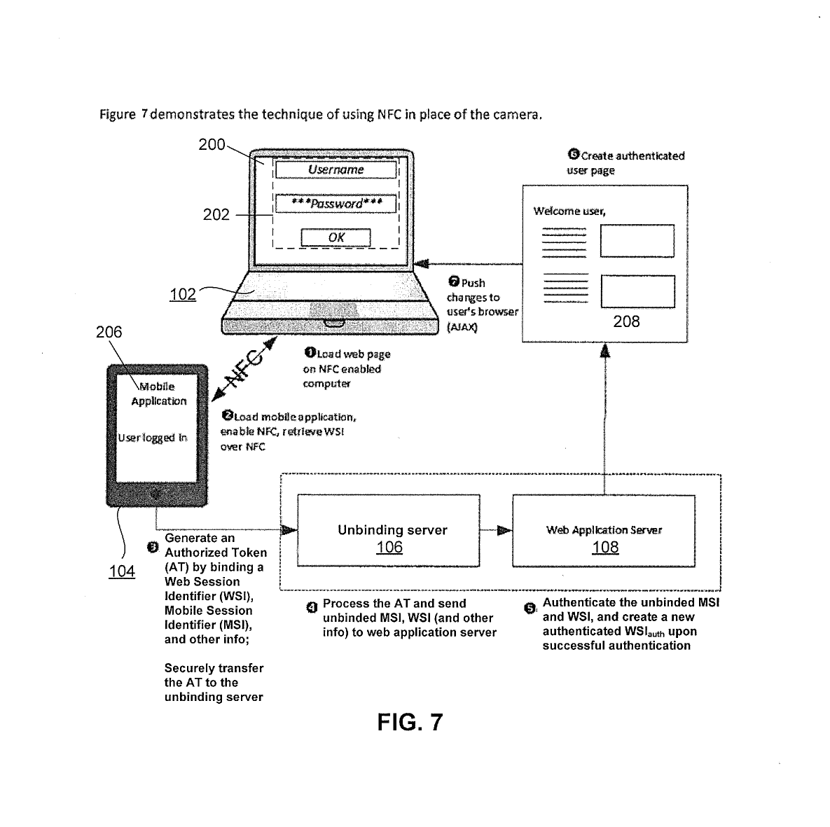

FIG. 7 is a functional block diagram of another embodiment of the no-click log-in access system of FIG. 1 using Near Field Communication (NFC) in place of a camera on a mobile device. Similar to the embodiment of FIG. 2, the modules and interfaces in FIG. 7 can generally be categorized into each of three components: (1) computing device 102; (2) mobile device 104; and (3) unbinding server 106 and web application server 108.

In the example of FIG. 7, wireless communication devices such as NFC is used as the link between computing device 102 and mobile device 104. In these embodiments, any wireless communication devices attached to computing device 102, that can be accessed by both the web-browser on computing device 102 and mobile application 206 on mobile device 104, can be used to send information such as a Web Session Identifier (WSI) from computing device 102 to mobile application 206. It is noted that a camera on mobile device 104 and visual code 204 is not necessary in the embodiment described in FIG. 7.

In the example of FIG. 7, the transfer of the WSI from computing device 102 to mobile device 104 is performed over an NFC link. In other words, the WSI is transmitted from computing device 102 to mobile device 104 over the NFC link. In contrast, the example in FIG. 2 relies on a built-in camera and VCDS 208 in mobile application 206 on mobile device 104 to scan code 204, and derive the WSI contained in code 204.

When the NFC link is used to transmit the WSI, it is noted that special permissions may be required to enable NFC communication between computing device 102 and mobile device 104, and for the web-browser to access an NFC sensor in computing device 102.

As shown in step 1 of FIG. 7, a user first loads a webpage 200 on an NFC-enabled computing device 102. Webpage 200 includes log-in window 202, which offers the user the conventional method of logging in to the user's account by entering the user's credentials in log-in window 202.

Next, at step 2, the mobile device 104 loads mobile application 206 to enable NFC. Subsequently, mobile application 206 can retrieve (through the NFC) the WSI associated with webpage 200 on computing device 102. After the WSI has been retrieved, mobile application 206 generates an authorized token by binding the WSI and a Mobile Session Identifier (MSI) (and additional information as described previously with reference to FIGS. 2-6). The MSI corresponds to an already authenticated session on the mobile device 104 or the necessary credentials to authenticate a session. After generating the authorized token, mobile device 104 securely transfers the authorized token to unbinding server 106 (step 3).

Next, at step 4, unbinding server 106 processes the authorized token by unbinding the authorized token to retrieve the WSI and MSI (and any other information), and transmits the unbinded WSI and MSI to web application server 108. Following that, web application server 108 authenticates the unbinded WSI and MSI, creates a new authenticated WSIₐᵤₜₕ after a successful authentication (step 5), and creates an authenticated updated webpage 208 (step 6).

In step 7, website updates can be asynchronously pushed from web application server 108 to the web-browser on computing device 102 if the website includes an AJAX framework or a similar “push” framework. That is, after the user has signed up and logged into the web account, web application server 108 can asynchronously update and push the page that would have been displayed if the user had logged in using the keyboard to type in his credentials. Thus, in some embodiments, web application server 108 can access and control any open web session using asynchronous push messages.

It is understood that the above-described exemplary embodiments are for illustrative purposes only and are not restrictive of the claimed subject matter. Certain parts of the system can be deleted, combined, or rearranged, and additional parts can be added to the system. It will, however, be evident that various modifications and changes may be made without departing from the broader spirit and scope of the claimed subject matter as set forth in the claims that follow. The specification and drawings are accordingly to be regarded as illustrative rather than restrictive. Other embodiments of the claimed subject matter may be apparent to those skilled in the art from consideration of the specification and practice of the claimed subject matter disclosed herein.

The work that led to the development of the subject matter described herein, was co-financed by Hellenic Funds and by the European Regional Development Fund (ERDF) under the Hellenic National Strategic Reference Framework (ESPA) 2007-2013, according to Contract no. MICRO2-08.

What is claimed is:

1. A method for authenticating a user using a mobile device, the method comprising:
acquiring a web session identifier from a code provided on an entry webpage that is displayed on a computing device;
generating an authorized token having information corresponding to the web session identifier and a mobile session identifier that corresponds to either an authenticated session with a service provider of the webpage or credentials to authenticate a session with the service provider; and
providing the authorized token to a server, which receives the information corresponding to at least the web session identifier and the mobile session identifier from the authorized token, and uses at least the web session identifier and the mobile session identifier to authenticate the user with the service provider for providing access to a user-specific webpage that replaces the entry webpage on the computing device.

2. The method of claim 1, further comprising initiating an application associated with the service provider.

3. The method of claim 2, wherein acquiring a web session identifier from a code provided on the entry webpage that is displayed on a computing device comprises:
scanning the code using the application and a camera on the mobile device to acquire the web session identifier.

4. The method of claim 2, wherein acquiring a web session identifier from a code provided on the entry webpage that is displayed on a computing device comprises:
using the application on the mobile device to acquire the web session identifier over a Near Field Communication link.

5. The method of claim 2, wherein the application includes a Visual Code Detection Screen.

6. The method of claim 1, wherein the credentials to authenticate a session with the service provider include the user's log-in credentials for accessing the user-specific webpage.

7. The method of claim 1, wherein the code can be a one-dimensional barcode, a two-dimensional barcode, or a sequence of alphanumeric characters.

8. The method of claim 1, wherein the authorized token is generated by binding the web session identifier and the mobile session identifier.

9. The method of claim 8, wherein the server obtains the information by unbinding the web session identifier and the mobile session identifier from the authorized token.

10. The method of claim 1, further comprising:
receiving a download uniform resource locator for a webpage that has been populated with the user's credential information;
accessing the download uniform resource locator; and
install a mobile application on the mobile device.

11. A method for authenticating a user using one or more servers, the method comprising:
generating an entry webpage that includes a code having a web session identifier, wherein the entry webpage is configured to be displayed on a computing device;
receiving at least the web session identifier and a mobile session identifier that corresponds to either an authenticated session with a service provider of the webpage or credentials to authenticate a session with the service provider;
authenticating the user using the web session identifier and the mobile session identifier; and
providing a user-specific webpage that replaces the entry webpage on the computing device.

12. The method of claim 11, wherein the web session identifier can be acquired using an application and a camera on a mobile device to scan the code.

13. The method of claim 11, wherein the web session identifier can be acquired using an application on a mobile device over a Near Field Communication link.

14. The method of claim 11, wherein the credentials to authenticate a session with the service provider include the user's log-in credentials for accessing the user-specific webpage.

15. The method of claim 11, wherein the code can be a one-dimensional barcode, a two-dimensional barcode, or a sequence of alphanumeric characters.

16. The method of claim 11, wherein at least the web session identifier and the mobile session identifier are received as an authorized token.

17. The method of claim 16, wherein at least the web session identifier and the mobile session identifier are binded in the authorized token.

18. The method of claim 17, further comprising:
unbinding at least the web session identifier and the mobile session identifier from the authorized token.

19. A tangible computer readable medium storing instructions that, when executed by one or more servers, cause the one or more servers to perform a method of authenticating a user, the method comprising:
generating an entry webpage that includes a code having a web session identifier, wherein the entry webpage is configured to be displayed on a computing device;
acquiring the web session identifier from the code;
generating an authorized token having information corresponding to at least the web session identifier and a mobile session identifier that corresponds to either an authenticated session with a service provider of the webpage or credentials to authenticate a session with the service provider; and
receiving at least the web session identifier and a mobile session identifier that corresponds to either an authenticated session with a service provider of the webpage or credentials to authenticate a session with the service provider;
authenticating the user by the one or more servers based on at least the web session identifier and the mobile session identifier; and
providing by the one or more servers a user-specific webpage that replaces the entry webpage on the computing device.
